(19) United States
(12) Patent Application Publication
(10) Pub. No.: US 2020/0136478 A1
(43) Pub. Date: Apr. 30, 2020

(54) ELECTRIC MOTOR WITH SENSORS

(71) Applicant: STOLLMEYER TECHNOLOGIES, LLC, San Luis Obispo, CA (US)

(72) Inventors: MARCUS RICHARD STOLLMEYER, SANTA MARIA, CA (US); JOSEPH RILEY COPLON, SAN LUIS OBISPO, CA (US)

(21) Appl. No.: 16/177,267

(22) Filed: Oct. 31, 2018

(51) Int. Cl. H02K 11/27; B64C 39/02; H02K 15/14; H02K 11/30; H02K 11/25

(52) U.S. Cl. CPC H02K 11/27; B64C 39/024; B64C 2201/042; H02K 11/30; H02K 11/25; H02K 15/14

(57) ABSTRACT

A motor unit system is described that includes a housing, a brushless direct current motor comprising a shaft and a winding, the shaft extending from inside the housing to outside of the housing through a hole at the one end of the housing or another end of the housing, the other end of the housing being opposite the one end of the housing, the winding being contained within the housing, a motor controller contained within the housing, and a motor sensor contained within the housing. The motor sensor may include a current sensor, a temperature sensor, or both.

This application relates to the following applications filed concurrently herewith. The related applications, all of which are incorporated herein by reference, are:

Attorney Docket No. 20966-143349-US, U.S. patent application Ser. No.______, of Stollmeyer, et al., entitled ELECTRIC MOTOR WITH NAVIGATIONAL LIGHT;

Attorney Docket No. 20966-143350-US, U.S. patent application Ser. No.______, of Stollmeyer, et al., entitled ELECTRIC MOTOR WITH AN INTEGRAL MOTOR CONTROLLER; and

Attorney Docket No. 20966-143351-US, U.S. patent application Ser. No.______, of Stollmeyer, et al., entitled ELECTRIC MOTOR WITH INTEGRATED MOTOR CONTROLLER.

### BACKGROUND OF THE INVENTION

### 1. Field of the Invention

The present invention relates generally to an electric motor, and more specifically to an electric motor that incorporates current and temperature sensors.

### 2. Discussion of the Related Art

Various systems and processes are known in the art for designing an electric motor. However, in many cases a motor controller for the electric motor is located separately from the motor itself. In this case, the sensors that provide data for the motor controller may be located separately from the motor controller, which may result in an inefficient and unintegrated design.

### SUMMARY

A motor unit system is described. The motor unit system may include a housing comprising a plurality of mounting holes on one end of the housing, a brushless direct current motor comprising a shaft and a winding, the shaft extending from inside the housing to outside of the housing through a hole at the one end of the housing or another end of the housing, the other end of the housing being opposite the one end of the housing, the winding being contained within the housing, a motor controller contained within the housing, and a motor sensor contained within the housing.

An unmanned vehicle is described. The unmanned vehicle may include a frame, one or more propulsion units, and a motor unit system; the motor unit system including a housing comprising a plurality of mounting holes on one end of the housing, a brushless direct current motor comprising a shaft and a winding, the shaft extending from inside the housing to outside of the housing through a hole at the one end of the housing or another end of the housing, the other end of the housing being opposite the one end of the housing, the winding being contained within the housing, a motor controller contained within the housing, and a motor sensor contained within the housing.

A method of manufacturing a motor unit system is described. The method may include providing a housing comprising a plurality of mounting holes on one end of the housing, providing a brushless direct current motor comprising a shaft and a winding, the shaft extending from inside the housing to outside of the housing through a hole at the one end of the housing or another end of the housing, the other end of the housing being opposite the one end of the housing, the winding being contained within the housing, providing a motor controller contained within the housing, and providing a motor sensor contained within the housing.

In some examples of the motor unit system, unmanned vehicle, and method described above, the motor sensor comprises a current sensor. Some examples of the motor unit system, unmanned vehicle, and method described above may further include a connector accessible through an opening in the housing, the connector comprising a pair of contacts electrically coupled to the motor controller at a control input of the motor controller, and an additional contact electrically coupled to the motor sensor. In some examples of the motor unit system, unmanned vehicle, and method described above, the motor sensor further comprises a temperature sensor.

Some examples of the motor unit system, unmanned vehicle, and method described above may further include a connector accessible through an opening in the housing, the connector comprising a pair of contacts electrically coupled to the motor controller at a control input of the motor controller, and an additional contact electrically coupled to the motor sensor.

Some examples of the motor unit system, unmanned vehicle, and method described above may further include a connector accessible through an opening in the housing, the connector comprising a pair of contacts electrically coupled to the motor controller at a control input of the motor controller, and an additional contact electrically coupled to the motor sensor. In some examples of the motor unit system, unmanned vehicle, and method described above, the motor sensor further comprises a temperature sensor.

### BRIEF DESCRIPTION OF THE DRAWINGS

FIG. 1 shows an example of a perspective view of a motor unit system of an unmanned vehicle in accordance with aspects of the present disclosure.

FIG. 2 shows an example of a front view of a motor unit system in accordance with aspects of the present disclosure.

FIG. 3 shows an example of a side view of a motor unit system in accordance with aspects of the present disclosure.

FIG. 4 shows an example of a motor controller in accordance with aspects of the present disclosure.

FIG. 5 shows an example of an exploded view of a motor unit system in accordance with aspects of the present disclosure.

FIG. 6 shows an example of a schematic of a motor unit system in accordance with aspects of the present disclosure.

FIG. 7 shows an example of a process for manufacturing a motor unit system in accordance with aspects of the present disclosure.

### DETAILED DESCRIPTION

The present disclosure describes a motor unit system that includes a motor, a motor controller, and motor sensors all located within a same housing. This may enable a more integrated, convenient, and space efficient design than a system in which one or more of these components are located separately. The motor sensors may include a current sensor, a temperature sensor, or both.

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

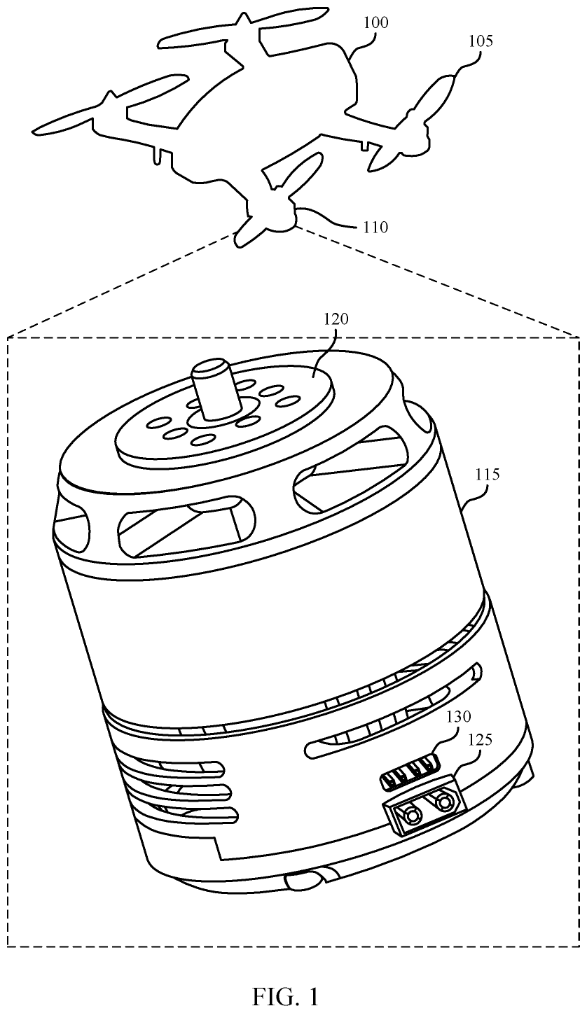

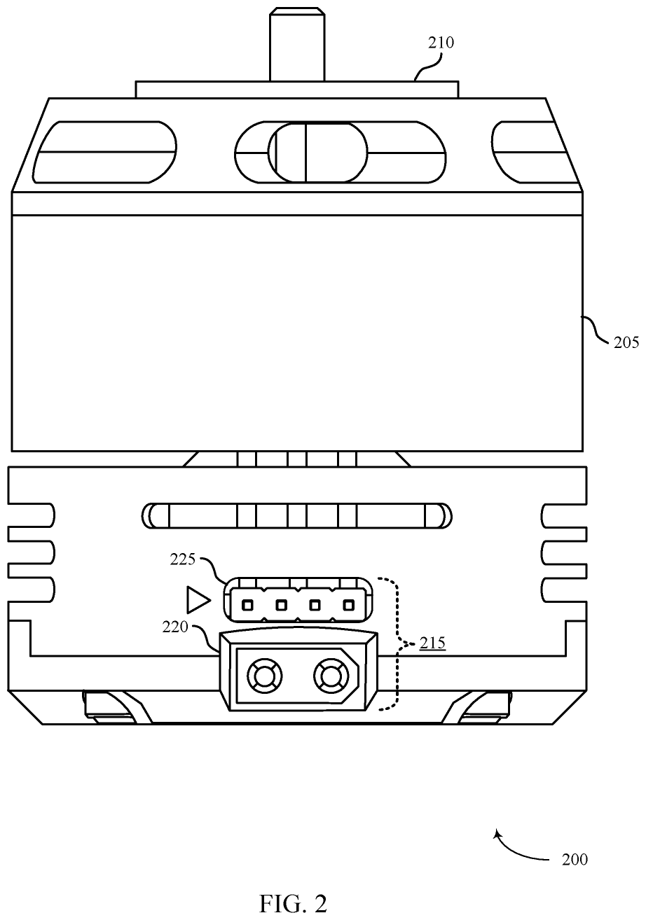

FIG. 1 shows an example of a perspective view of a motor unit system 110 of an unmanned vehicle 100 in accordance with aspects of the present disclosure. Unmanned vehicle 100 may include propulsion unit 105 and motor unit system 110. Motor unit system 110 may be an example of, or include aspects of, the corresponding elements described with reference to FIGS. 2, 3, 5, and 6.

In some embodiments, the motor unit system 110 may be combined with other components to produce an unmanned aerial vehicle (UAV). By combining a motor 120 with a light source and an electronic speed control (ESC), the motor unit system 110 may enable faster and easier assembly as well as more robust performance. The ESC may be a component of a motor controller. One or more motor sensors (not shown) may be located in the same housing as the motor and the motor controller.

Some embodiments may be used in conjunction with a connector system that enables quick assembly without soldering. In some cases, the motor unit system 110 may also include a built-in direction switch and nav light switch.

The motor unit system 110 may be configured with elements that enable durable and reliable performance in a variety of flight conditions. For example, an internal ESC may be conformally coated to protect the motor unit system 110 from damage in wet conditions.

In one embodiment, the motor 120 may operate at 3,515 revolutions per minute (RPM) and 500 kV. An example shaft size may be 4 mm, and an example weight for the motor unit system 110 may be from 150-200 g. The input voltage range may be between 10V-25.5V.

In some examples, the motor unit system 110 may be used in conjunction with a battery power source. For example, the battery may be a 4 cell to 6 cell Lithium polymer (LiPo) battery with 14.8v-22.2v Continuous Current, and 20 Amps (500 W), with a burst current of 35 Amps. However, one skilled in the art will recognize that other battery systems may be suitable for powering the motor unit system 110.

In some examples, the motor unit system 110 may be connected to a frame of a UAV, and may power a propulsion unit 105 such as a propeller. For example, the propulsion unit 105 for a multi-rotor vehicle may have a 12-inch to 15-inch Diameter, with a 3-inch to 5-inch pitch. For a fixed wing vehicle, the propulsion unit 105 may have a 9-inch to 13-inch Diameter, with a 5-inch to 9-inch pitch. In one embodiment, the total vehicle weight for a multi-rotor vehicle may be up to 1.5 KG per motor 120. In some fixed wing embodiments, the total weight may be up to 4 KG per motor 120.

The motor 120 may be powerful enough to lift wide array of vehicles and payloads, and may be durable and reliable enough to perform in a wide variety of conditions. In some examples, the ESC may be pre-tuned for precision and efficiency, and may be conformally coated to increased reliability. The light source may enable line-of-sight flying, and may greatly improve visibility and safety. By combining the light source with the motor 120 unit, the vehicle may achieve a desirable form factor. In some examples, a switch on the back of the motor unit system 110 may allow a user to dictate the direction of the rotor rotation.

The motor unit system 110 may be configured with one or more solder-free connection points, so that the motor unit system 110 may be simply plugged into a vehicle. In some examples, the motor unit system 110 may include, or may be packaged with a pre-soldered cable and a connector 130 system to connect the motor unit system 110 to a power input 125, a throttle input, and a propulsion unit 105.

Motor unit system 110 may include housing 115, motor 120, power input 125, and connector 130. Housing 115 may include a plurality of mounting holes on one end of the housing 115. Housing 115 may be an example of, or include aspects of, the corresponding elements described with reference to FIGS. 2, 3, and 5.

Motor 120 may include a shaft and a winding, the shaft extending from inside the housing 115 to outside of the housing 115 through a hole at the one end of the housing 115 or another end of the housing 115, the other end of the housing 115 being opposite the one end of the housing 115, the winding being contained within the housing 115. Motor 120 may be an example of, or include aspects of, the corresponding elements described with reference to FIGS. 2, 3, 5, and 6.

Power input 125 may be an example of, or include aspects of, the corresponding elements described with reference to FIGS. 2-6.

Connector 130 may be accessible through an opening in the housing 115, the connector 130 including a pair of contacts electrically coupled to the motor controller at a control input of the motor controller, and an additional contact electrically coupled to the motor sensor.

Connector 130 may be accessible through an opening in the housing 115, the connector 130 including a pair of contacts electrically coupled to the motor controller at a control input of the motor controller, and an additional contact electrically coupled to the motor sensor. Connector 130 may also include an additional contact electrically coupled to the motor sensor. Connector 130 may be an example of, or include aspects of, the corresponding elements described with reference to FIGS. 2-6.

FIG. 2 shows an example of a front view of a motor unit system 200 in accordance with aspects of the present disclosure. Motor unit system 200 may be an example of, or include aspects of, the corresponding elements described with reference to FIGS. 1, 3, 5, and 6. Motor unit system 200 may include housing 205, motor 210, opening 215, power input 220, and connector 225.

Housing 205 may be an example of, or include aspects of, the corresponding elements described with reference to FIGS. 1, 3, and 5. Motor 210 may be an example of, or include aspects of, the corresponding elements described with reference to FIGS. 1, 3, 5, and 6.

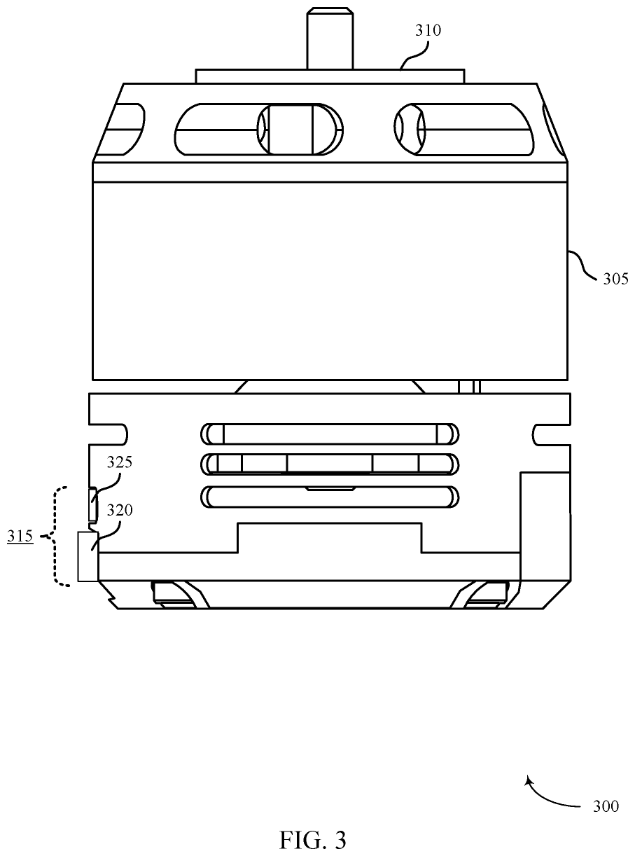

Opening 215 may be an example of, or include aspects of, the corresponding elements described with reference to FIG. 3. Power input 220 and connector 225 may be examples of, or include aspects of, the corresponding elements described with reference to FIGS. 1, and 3-6.

FIG. 3 shows an example of a side view of a motor unit system 300 in accordance with aspects of the present disclosure. Motor unit system 300 may be an example of, or include aspects of, the corresponding elements described with reference to FIGS. 1, 2, 5, and 6. Motor unit system 300 may include housing 305, motor 310, opening 315, power input 320, and connector 325.

Housing 305 may be an example of, or include aspects of, the corresponding elements described with reference to FIGS. 1, 2, and 5. Motor 310 may be an example of, or include aspects of, the corresponding elements described with reference to FIGS. 1, 2, 5, and 6.

Opening 315 may be an example of, or include aspects of, the corresponding elements described with reference to FIG. 2. Power input 320 and connector 325 may be examples of, or include aspects of, the corresponding elements described with reference to FIGS. 1, 2, and 4-6.

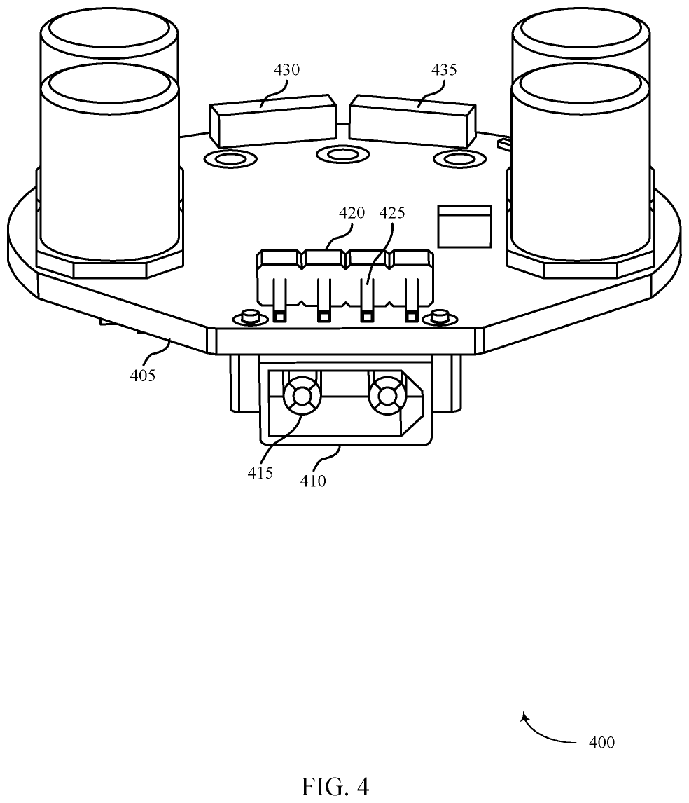

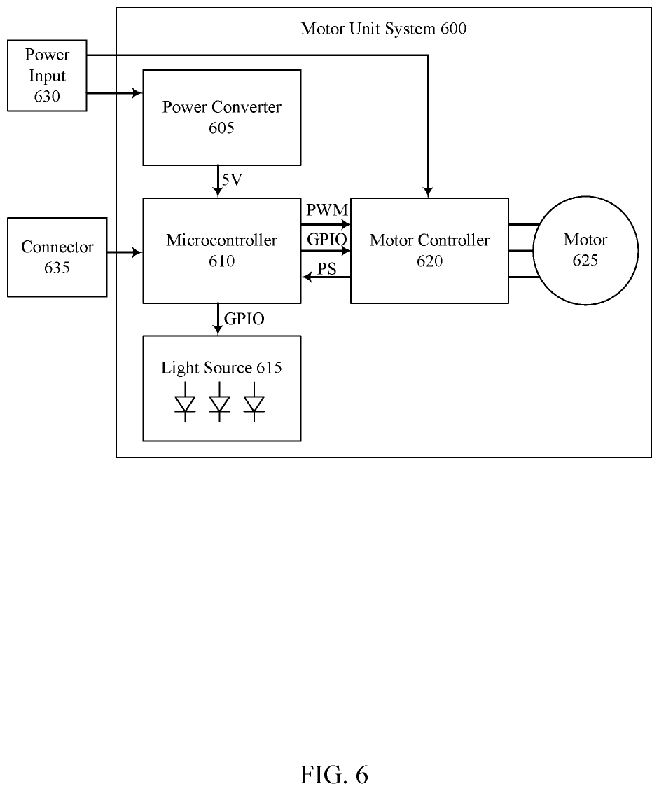

FIG. 4 shows an example of a motor controller 400 in accordance with aspects of the present disclosure. Motor controller 400 be contained within a motor unit housing. Motor controller 400 may be an example of, or include aspects of, the corresponding elements described with reference to FIG. 6. Motor controller 400 may include circuit board 405, power input 410, connector 420, current sensor 430, and temperature sensor 435.

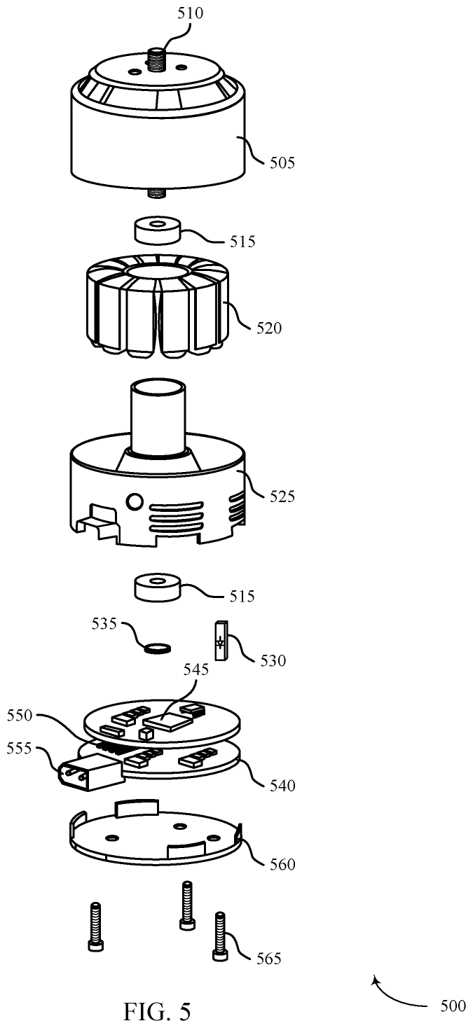

The current sensor 430, and the temperature sensor 435 provide valuable data that can be utilized by the motor controller 400 or by a flight controller within the UAV (but outside the motor unit housing) to monitor the heath and performance of the motor unit system 500 (FIG. 5.) for purposes of live analysis over the motor unit system 500 lifespan.

Circuit board 405 may be an example of, or include aspects of, the corresponding elements described with reference to FIG. 5.

Power input 410 and connector 420 may be examples of, or include aspects of, the corresponding elements described with reference to FIGS. 1-3, 5, and 6. Power input 410 may include power pins 415. Connector 420 may include data pins 425.

Motor sensors may be contained within the housing, e.g., on circuit board 405. However, the motor sensors may be located in a position other than on circuit board 405, such as mounted to the housing or the motor. In some examples, the motor sensors include a current sensor 430. In some examples, the motor sensor further includes a temperature sensor 435. The current sensor 430 and temperature sensor 435 may be an example of a motor sensor 440 described with reference to FIG. 5.

FIG. 5 shows an example of an exploded view of a motor unit system 500 in accordance with aspects of the present disclosure. Motor unit system 500 may be an example of, or include aspects of, the corresponding elements described with reference to FIGS. 1-3, and 6.

Motor unit system 500 may include motor 505, shaft 510, ball bearing 515, winding 520, housing 525, light source 530, lock clip 535, circuit board 540, motor sensor 545, connector 550, power input 555, bottom cover 560, and fasteners 565.

Motor 505 may be an example of, or include aspects of, the corresponding elements described with reference to FIGS. 1-3, and 6. Housing 525 may be an example of, or include aspects of, the corresponding elements described with reference to FIGS. 1-3.

Light source 530 may be an example of, or include aspects of, the corresponding elements described with reference to FIG. 6. Circuit board 540 and motor sensor 545 may include a current sensor and/or a temperature sensor as described with reference to FIG. 4. Connector 550 and power input 555 may be examples of, or include aspects of, the corresponding elements described with reference to FIGS. 1-4, and 6.

FIG. 6 shows an example of a schematic of a motor unit system 600 in accordance with aspects of the present disclosure. The example shown includes motor unit system 600, power input 630, and connector 635. Motor unit system 600 may be an example of, or include aspects of, the corresponding elements described with reference to FIGS. 1-3, and 5. Motor unit system 600 may include power converter 605, microcontroller 610, light source 615, motor controller 620, and motor 625.

Light source 615 may be an example of, or include aspects of, the corresponding elements described with reference to FIG. 5. Motor controller 620 may be an example of, or include aspects of, the corresponding elements described with reference to FIG. 4. Motor 625 may be an example of, or include aspects of, the corresponding elements described with reference to FIGS. 1-3, and 5. Power input 630 and connector 635 may be examples of, or include aspects of, the corresponding elements described with reference to FIGS. 1-5.

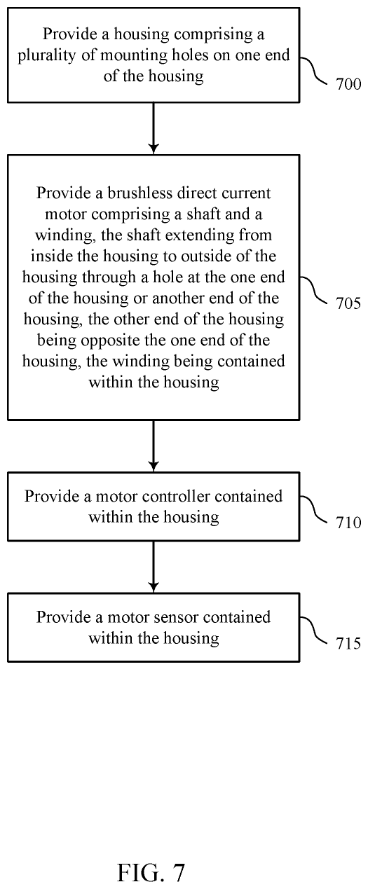

FIG. 7 shows an example of a process for manufacturing a motor unit system in accordance with aspects of the present disclosure. In some examples, these operations may be performed by a processor executing a set of codes to control functional elements of a manufacturing apparatus. Additionally or alternatively, the processes may be performed manually, or using special-purpose hardware. Generally, these operations may be performed according to the methods and processes described in accordance with aspects of the present disclosure. For example, the operations may be composed of various substeps, or may be performed in conjunction with other operations described herein.

At step 700, a manufacturing apparatus may provide a housing including a plurality of mounting holes on one end of the housing. In some cases, the operations of this step may refer to, or be performed by, a housing as described with reference to FIGS. 1-3, and 5.

At step 705, a manufacturing apparatus may provide a brushless direct current motor including a shaft and a winding, the shaft extending from inside the housing to outside of the housing through a hole at the one end of the housing or another end of the housing, the other end of the housing being opposite the one end of the housing, the winding being contained within the housing. In some cases, the operations of this step may refer to, or be performed by, a motor as described with reference to FIGS. 1-3, 5, and 6.

At step 710, a manufacturing apparatus may provide a motor controller contained within the housing. In some cases, the operations of this step may refer to, or be performed by, a motor controller as described with reference to FIGS. 4 and 6.

At step 715, a manufacturing apparatus may provide a motor sensor contained within the housing. In some cases, the operations of this step may refer to, or be performed by, a motor sensor as described with reference to FIGS. 4 and 5.

While the invention herein disclosed has been described by means of specific embodiments, examples and applications thereof, numerous modifications and variations could be made thereto by those skilled in the art without departing from the scope of the invention set forth in the claims.

What is claimed is:

1. A motor unit system, comprising:
a housing comprising a plurality of mounting holes on one end of the housing;
a brushless direct current motor comprising a shaft and a winding, the shaft extending from inside the housing to outside of the housing through a hole at the one end of the housing or another end of the housing, the other end of the housing being opposite the one end of the housing, the winding being contained within the housing;
a motor controller contained within the housing; and
a motor sensor contained within the housing.

2. The motor unit system of claim 1, wherein:
the motor sensor comprises a current sensor.

3. The motor unit system of claim 2, the motor unit system further comprising:
a connector accessible through an opening in the housing, the connector comprising a pair of contacts electrically coupled to the motor controller at a control input of the motor controller, and an additional contact electrically coupled to the motor sensor.

4. The motor unit system of claim 2, wherein:
the motor sensor further comprises a temperature sensor.

5. The motor unit system of claim 4, the motor unit system further comprising:
a connector accessible through an opening in the housing, the connector comprising a pair of contacts electrically coupled to the motor controller at a control input of the motor controller, and an additional contact electrically coupled to the motor sensor.

6. The motor unit system of claim 5, the motor unit system further comprising:
a connector accessible through an opening in the housing, the connector comprising a pair of contacts electrically coupled to the motor controller at a control input of the motor controller, and an additional contact electrically coupled to the motor sensor.

7. The motor unit system of claim 1, wherein:
the motor sensor further comprises a temperature sensor.

8. An unmanned vehicle comprising: a frame, one or more propulsion units, a battery unit; and a motor unit system; the motor unit system further comprising:
a housing comprising a plurality of mounting holes on one end of the housing;
a brushless direct current motor comprising a shaft and a winding, the shaft extending from inside the housing to outside of the housing through a hole at the one end of the housing or another end of the housing, the other end of the housing being opposite the one end of the housing, the winding being contained within the housing;
a motor controller contained within the housing; and
a motor sensor contained within the housing.

9. The unmanned vehicle of claim 8, wherein:
the motor sensor comprises a current sensor.

10. The unmanned vehicle of claim 9, the unmanned vehicle further comprising:
a connector accessible through an opening in the housing, the connector comprising a pair of contacts electrically coupled to the motor controller at a control input of the motor controller, and an additional contact electrically coupled to the motor sensor.

11. The unmanned vehicle of claim 9, wherein:
the motor sensor further comprises a temperature sensor.

12. The unmanned vehicle of claim 11, the unmanned vehicle further comprising:
a connector accessible through an opening in the housing, the connector comprising a pair of contacts electrically coupled to the motor controller at a control input of the motor controller, and an additional contact electrically coupled to the motor sensor.

13. The unmanned vehicle of claim 12, the unmanned vehicle further comprising:
a connector accessible through an opening in the housing, the connector comprising a pair of contacts electrically coupled to the motor controller at a control input of the motor controller, and an additional contact electrically coupled to the motor sensor.

14. The unmanned vehicle of claim 8, wherein:
the motor sensor further comprises a temperature sensor.

15. A method of manufacturing a motor unit system, the method comprising:
providing a housing comprising a plurality of mounting holes on one end of the housing;
providing a brushless direct current motor comprising a shaft and a winding, the shaft extending from inside the housing to outside of the housing through a hole at the one end of the housing or another end of the housing, the other end of the housing being opposite the one end of the housing, the winding being contained within the housing;
providing a motor controller contained within the housing; and
providing a motor sensor contained within the housing.

16. The method of claim 15, wherein:
the motor sensor comprises a current sensor.

17. The method of claim 16, the method further comprising:
providing a connector accessible through an opening in the housing, the connector comprising a pair of contacts electrically coupled to the motor controller at a control input of the motor controller, and an additional contact electrically coupled to the motor sensor.

18. The method of claim 16, wherein:
the motor sensor further comprises a temperature sensor.

19. The method of claim 18, the method further comprising:
providing a connector accessible through an opening in the housing, the connector comprising a pair of contacts electrically coupled to the motor controller at a control input of the motor controller, and an additional contact electrically coupled to the motor sensor.

20. The method of claim 19, the method further comprising:
providing a connector accessible through an opening in the housing, the connector comprising a pair of contacts electrically coupled to the motor controller at a control input of the motor controller, and an additional contact electrically coupled to the motor sensor.
